(19) United States
(12) Patent Application Publication
(10) Pub. No.: US 2018/0294482 A1
(43) Pub. Date: Oct. 11, 2018

(54) MIXED BINDERS

(71) Applicant: Kitty Hawk Corporation, Mountain View, CA (US)

(72) Inventors: Chen Li, Santa Clara, CA (US); Patrick K. Herring, Redwood City, CA (US)

(21) Appl. No.: 15/484,501

(22) Filed: Apr. 11, 2017

(51) Int. Cl. H01M 4/62; C09J 179/08; C09J 5/06; H01M 4/38; H01M 4/04

(52) U.S. Cl. CPC H01M 4/622; C09J 179/08; C09J 5/06; H01M 4/386; H01M 4/625; H01M 2004/027; C09J 2479/00; C09J 2433/00; C09J 2203/33; C09J 2205/31; H01M 4/0471

(57) ABSTRACT

A mixed binder which includes a polyacrylic acid and a polyimide. The mixed binder is configured to bind an anode and a current collector in an electrode. The mixed binder is also configured to come into contact with an electrolyte solution in the electrode.

### BACKGROUND OF THE INVENTION

New types of electrodes are being developed which use higher-energy anode materials, such as silicon-based materials (e.g., silicon monoxide). However, existing binders do not work well with such electrodes. For example, some existing binders break down or are otherwise destroyed by the repeated expansion and contraction of the binder (e.g., caused by repeated exposure to a lithium-based electrolyte solution). This repeated and large volumetric expansion and contraction causes the binders to crack and/or collapse over time. Some binders hold up well even with repeated expansion and contraction, but do not adhere well to other materials in the electrode. New types of binders with good adhesiveness and which are also able to withstand repeated expansion and contraction would be desirable.

### BRIEF DESCRIPTION OF THE DRAWINGS

Various embodiments of the invention are disclosed in the following detailed description and the accompanying drawings.

FIG. 1 is a diagram illustrating an embodiment of a silicon monoxide electrode which uses a mixed binder.

FIG. 2 shows two graphs which illustrate the improved performance with one embodiment of the mixed binder.

FIG. 3 shows a table and a graph which compare the first efficiency and first discharge profile of one embodiment of the mixed binder against other types of binders.

FIG. 4 is a diagram illustrating an embodiment of the effect of the curing process on a copper current collector.

FIG. 5 is a flowchart illustrating an embodiment of a stepwise curing process.

FIG. 6 is a graph showing an embodiment of a stepwise curing process.

FIG. 7 is a diagram illustrating an embodiment of a manufacturing process where calendering is skipped.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Various examples describing various aspects of a mixed binder are described herein. In some embodiments, the mixed binder includes a polyacrylic acid (PAA) and a polyimide (PI) where the mixed binder is configured to bind an anode composite material and a current collector into an electrode and come into contact with an electrolyte solution in the cell. First, some examples of an electrode which uses a mixed binder are described. Then, some examples describing manufacturing-related steps (e.g., when an electrode which uses a mixed binder is built) are described.

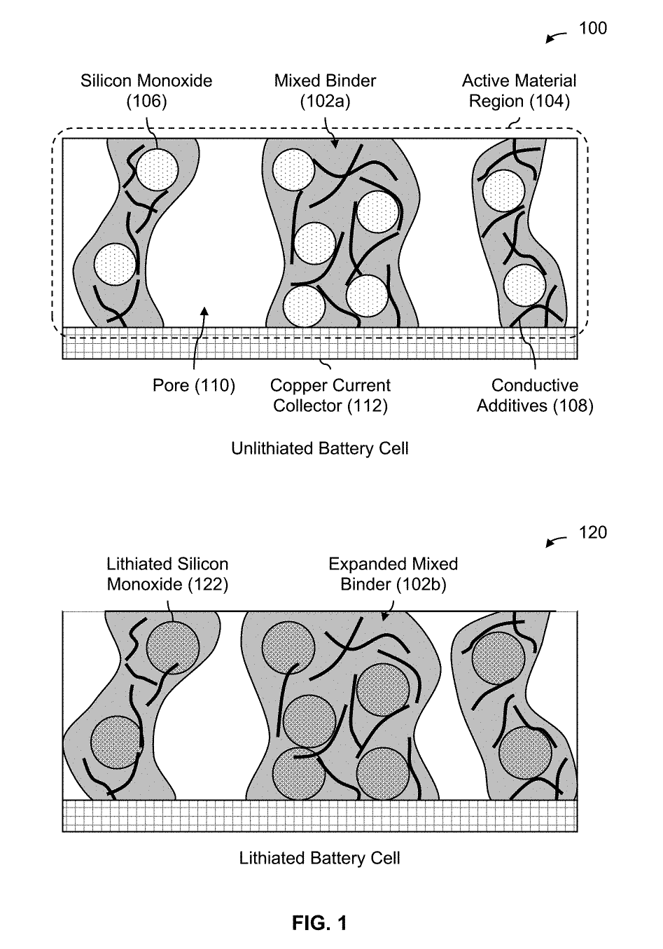

FIG. 1 is a diagram illustrating an embodiment of a silicon monoxide electrode which uses a mixed binder. Diagram 100 shows a cross sectional view of the exemplary electrode in an unlithiated state (e.g., before lithium is introduced into the anode system). In the example shown, the active material region (104) is formed using a mixed binder (102a) which includes a polyacrylic acid (PAA) and a polyimide (PI). In some embodiments, the polyacrylic acid is a polyacrylic acid with on the order of 250,000˜450,000 Mv. The mixed binder (102a) starts out in liquid or gel-like form and is mixed together with silicon monoxide particles (106) and with conductive additives (108) to form a slurry. The silicon monoxide particles act as the anode active material (more generally, these types of anodes are referred to as silicon-based anodes) and emit charge when lithium is alloyed with the active material. The conductive additives act as electrical conductors which facilitates charge transport from the silicon monoxide particles (106) to the copper (or, more generally, metal) current collector (112).

While the slurry (which includes the silicon monoxide, mixed binder, and carbon black) is still in gel-like liquid state, the slurry is spread on the copper current collector (112). Once the mixed binder dries, the electrode will contain pores (110). For example, the pores may form because water and/or other organic solvents in the wet mixed binder evaporate during the curing process, leaving behind the pores. As will be described in more detail below, a stepwise curing process may be used to dry the mixed binder, which prevents the copper current collector from wrinkling once lithium is introduced into the system.

Diagram 120 shows the same electrode when lithiated. The pores (110) in diagram 100 now shrink due to the expansion of the lithium hosting active material (122) which in this example is the lithiated silicon monoxide. Lithium hosting causes the active material to increase in volume and expands the binder matrix, including the mixed binder described herein. Note, for example, that the mixed binder (102a) in diagram 100 is smaller compared to the expanded mixed binder (102b) shown in diagram 120. Over the lifetime of the electrode (sometimes referred to as the electrode's cycle life), the electrode will go through many lithiation cycles (e.g., alternating between the unlithiated state shown in diagram 100 and the lithiated state shown in diagram 120). This causes the mixed binder to repeatedly expand and contract over the cycle life of the electrode.

For convenience and brevity, examples described herein talk about introducing lithium into the exemplary electrodes to produce a charge. In actuality, any appropriate lithium-based electrolyte solution may be used. For example, the solution may include some combination of ethylene carbonate (EC), ethyl-methyl carbonates (EMC), and/or dimethyl carbonate (DMC), as well as lithium hexafluorophosphate (LiPF6).

Similarly, although this example shows silicon monoxide particles as the anode and conductive additives as the electrical conductors, the mixed binder may be used with some other combinations of materials. In some embodiments, the mixed binder is used for some other (e.g., non-battery) application.

The mixed binder (which includes a polyacrylic acid and a polyimide) has certain properties which make it attractive for the electrode application shown. The degree of expansion and contraction of any binder which holds silicon-based active material is relatively large (i.e., any binder in such an electrode experiences significant volumetric change). The mixed binder is attractive because it has a high degree of elasticity and is able to retain its structural integrity after repeated and significant volumetric changes. The mixed binder will not (for example) develop cracks and/or collapse even after many lithiation cycles.

Another attractive property of the mixed binder is its adhesiveness. The mixed binder needs to securely attach to the other electrode components, such as the copper current collector, the silicon monoxide particles, and carbon black.

In contrast, other binders do not have both of these properties simultaneously. Some other binders have good elasticity (and are able to retain structural integrity even after repeated volumetric changes) but are not good adhesives. Other binders are good adhesives but cannot stand up to repeated expansions and contractions.

In some embodiments, the mixed binder also includes carboxymethyl cellulose (CMC). For example, including CMC in a mixed binder may be desirable in order to adjust the viscosity of the slurry for manufacturing purposes. In some embodiments, the mixed binder includes lithium hydroxide, which has the benefit of neutralizing the PAA and providing an additional source of lithium within the binder system.

The following figures show some performance measurements comparing the mixed binder to other types of binders.

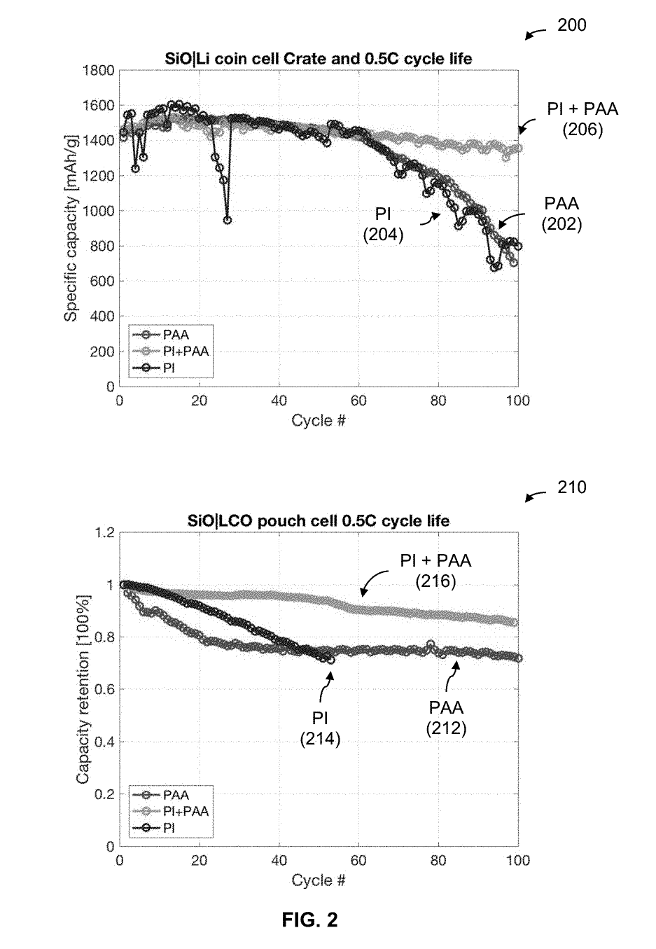

FIG. 2 shows two graphs which illustrate the improved performance with one embodiment of the mixed binder. In this example, the mixed binder which is plotted here includes 10% polyimide (PI) and 5% polyacrylic acid (PAA) by weight. Graph 200 shows the performance of a coin cell using silicon monoxide (SiO) as positive electrode and lithium (Li) as negative electrode with different types of binders. Each cycle along the x-axis is a lithiation cycle, where the active material is lithiated and then de-lithiates when the relative potential is reversed. The y-axis shows the specific capacity in milliamp hours (mAh) per gram (g). As shown here, the coin cell with the mixed PI and PAA binder (206) is better able to maintain its specific capacity compared to the coin cells with the PAA binder (202) and the PI binder (204). So if (as an example) a coin cell is required to have some minimum specific capacity, the mixed binder is able to extend the cycle life of the coin cell.

Diagram 210 shows a pouch cell application using silicon monoxide (SiO) as anode and lithium cobalt oxide (LCO) as cathode instead of a coin cell application. In this example, the x-axis shows the (lithiation) cycle number and the y-axis shows capacity retention in percentage (e.g., where all of the performance curves start out at 100% capacity and degrade from there). As before, the pouch cell with the mixed PI and PAA binder (216) better maintains its capacity compared to the pouch cells which use a PAA binder (212) and a PI binder (214).

Other types of cells which may use a mixed binder include cylindrical cells and prismatic cells (e.g., with either a wound or stacked configuration).

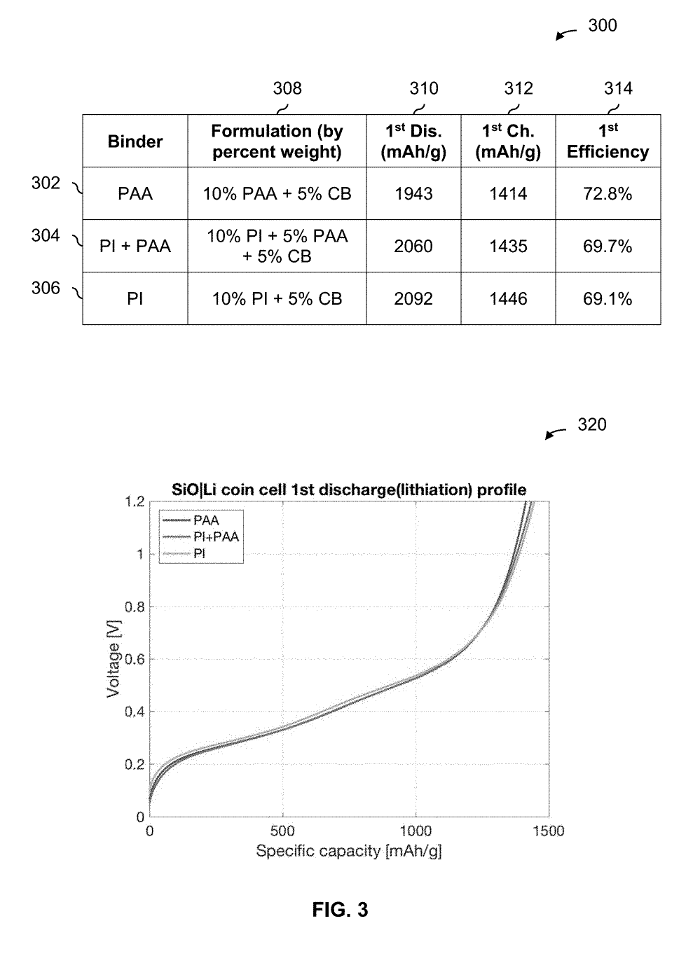

FIG. 3 shows a table and a graph which compare the first efficiency and first discharge profile of one embodiment of the mixed binder against other types of binders. Table 300 compares the first efficiency values for a PAA binder (row 302), mixed PI and PAA binder (row 304), and PI binder (row 306). Column 308 shows the formulation of each (by weight) where CB is carbon black. Column 310 shows the first discharge values (which is the specific capacity upon initial lithiation of the anode) for the different types of binders, column 312 shows the first charge values (which is the specific capacity during the initial de-lithiation of the anode) for the different types of binders, and column 314 shows the first efficiency (which is the ratio of the first charge to the first discharge). Note that all of the values are substantially close to each other, which means that the mixed binder has comparable performance for the metrics shown in table 300 and the improvement in lifespan described above in FIG. 2 does not come at the cost of the first efficiency, etc.

Graph 320 similarly shows that the increased cycle life does not come at the expense of the first discharge profile. Graph 320 shows the first discharge profile where the x-axis corresponds to specific capacity (in mAh/g) and the y-axis corresponds to voltage (in volts). As shown here, the performance curves for the PAA binder, the mixed PI and PAA binder, and the PI binder substantially overlap and all three types of binders have similar first discharge profiles.

The following figures discuss various examples associated with curing (e.g., to dry the mixed binder). As is described in more detail below, not all curing processes will produce desirable electrodes and/or outcomes.

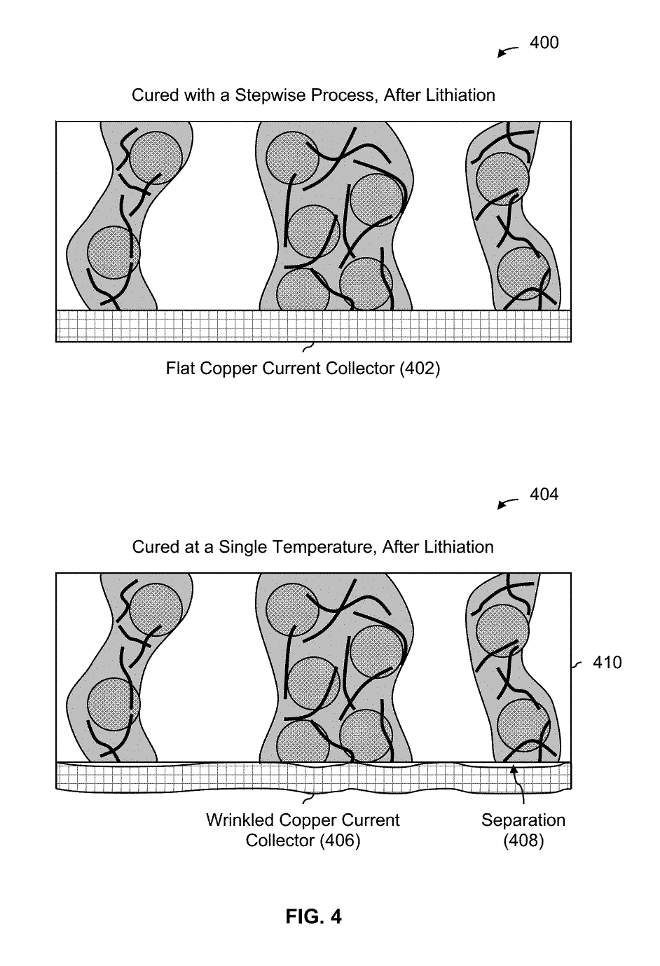

FIG. 4 is a diagram illustrating an embodiment of the effect of the curing process on a copper current collector. Diagram 400 shows an electrode which is cured using a stepwise process (e.g., heat at a first temperature is applied for a first period of time, then the heat is raised to a second, higher temperature for another period of time, and so on). Even after lithiation (e.g., where the lithium is introduced into the electrode), the copper current collector (402) remains flat.

Diagram 404 shows the same electrode with the same mixed binder, but this electrode is cured at a single temperature (e.g., the temperature is not gradually raised). For example, the electrode may have been cured at a single temperature in the range of 90° C. -100° C. After lithiation, the copper current collector (406) begins to wrinkle. This wrinkling of the copper current collector creates separations (408) between the copper current collector (406) and the active material region (410) and these separations are both structurally undesirable and electrically undesirable.

To avoid this wrinkling, a stepwise curing process may be used. The following figure describes one example.

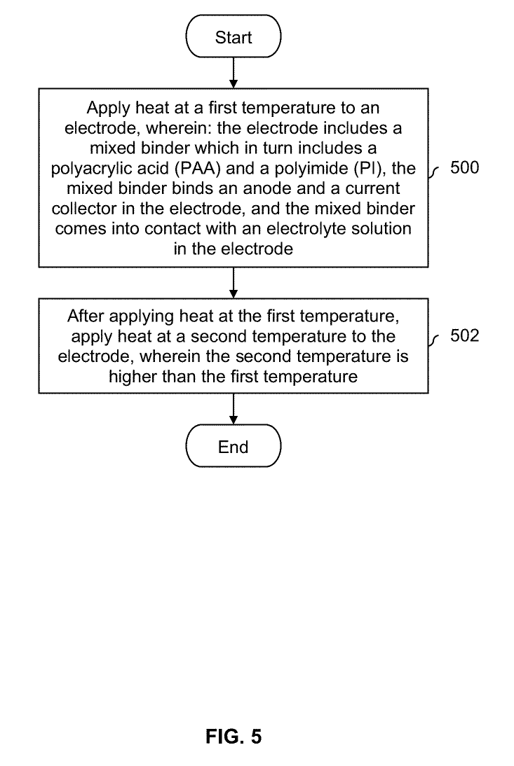

FIG. 5 is a flowchart illustrating an embodiment of a stepwise curing process. In some embodiments, the process is performed by a system, such as an oven. In some embodiments, there is some computer program product which controls an oven and the computer program product performs the steps shown.

At 500, heat at a first temperature is applied to an electrode, wherein: the electrode includes a mixed binder which in turn includes a polyacrylic acid (PAA) and a polyimide (PI), the mixed binder binds an anode and a current collector in the electrode, and the mixed binder comes into contact with an electrolyte solution in the electrode.

At 502, after applying heat at the first temperature, heat at a second temperature is applied to the electrode, wherein the second temperature is higher than the first temperature.

In some embodiments, there are additional (e.g., third, fourth, etc.) curing stages with additional, higher temperatures. In various embodiments, the temperatures are held (e.g., at step 500 and step 502) for a variety of time periods or durations. For example, the following figure shows a stepwise curing process with four curing stages where the temperatures are held for a variety of durations.

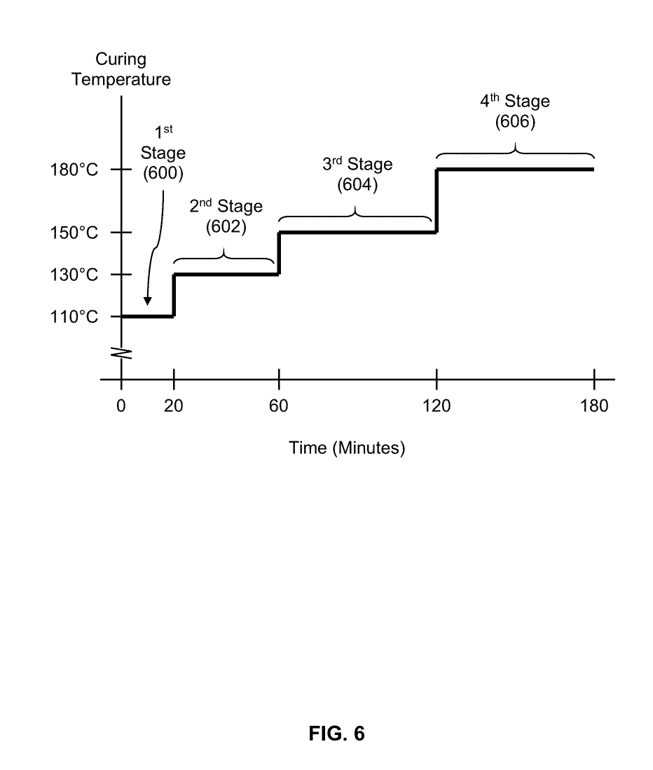

FIG. 6 is a graph showing an embodiment of a stepwise curing process. In the example shown, there are four curing stages. At the first stage (600), the temperature is set to 110° C. for 20 minutes (i.e., between time t=0 and 20). At the second stage (602), the temperature is set to 130° C. for 40 minutes (i.e., between time t=20 and 60). At the third stage (604), the temperature is set to 150° C. for 60 minutes (i.e., between time t=60 and 120). At the fourth stage (606), the temperature is set to 180° C. for 60 minutes (i.e., between time t=120 and 180).

A stepwise curing process can have as many steps as is desired and the duration and/or temperature associated with each stage may be set to a variety of values.

In addition to a different curing process, it may be desirable to skip a calendering (i.e., compressing) step when manufacturing the electrode. The following figure describes an example of this.

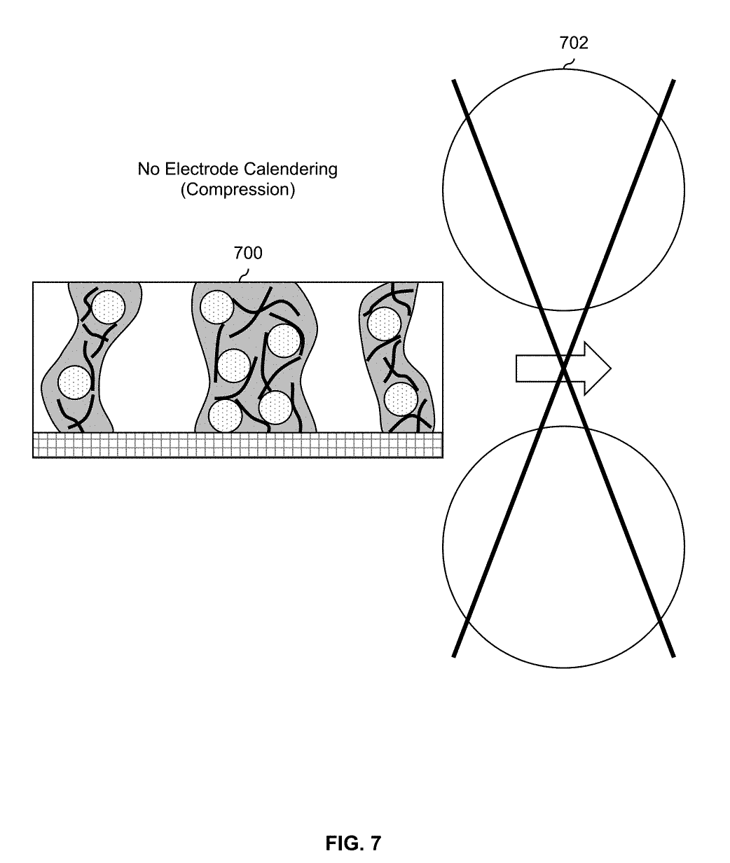

FIG. 7 is a diagram illustrating an embodiment of a manufacturing process where calendering is skipped. In the example shown, an electrode (700), which uses a mixed binder, has been coated on the current collector and curing has been performed. After curing, some other types of electrodes which use different types of binders (i.e., not mixed binders) are calendered by compressing the electrode between rollers (702). Calendering is performed on such electrodes to reduce the size of pores in the electrode and increase adhesion between silicon-based material and current collector (see, e.g., pore 110 in FIG. 1).

In this example, the step of calendering the electrode is skipped. In other words, electrodes with mixed binders are used in their un-calendered form. Skipping the calendering step produces electrodes with longer cycle lives because the inherent pore structure of the anode is preserved and allows the expansion of the active material into the pore space, reducing mechanical stress. This also prevents wrinkling of the current collector due to this reduction in mechanical stress during lithiation.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A mixed binder, comprising:
a polyacrylic acid; and
a polyimide, wherein:
the mixed binder includes a pore structure with a pore size adjustable by calendering, the mixed binder is configured to bind a silicon monoxide anode and a current collector in an electrode of a cell that further includes a lithium cobalt oxide cathode, a level of adhesiveness binding the anode and the current collector being is based at least in part on the calendering, and the adhesiveness is inversely related to the pore size;
the mixed binder is configured to come into contact with an electrolyte solution in the electrode;
the electrolyte solution includes a lithium-based electrolyte solution and includes one or more of the following: ethylene carbonate (EC), ethyl-methyl carbonates (EMC), dimethyl carbonate (DMC), or lithium hexafluorophosphate (LiPF6);
the mixed binder further includes carboxymethyl cellulose (CMC) and lithium hydroxide; and
the mixed binder includes 10% polyimide and 5% polyacrylic acid by weight.

2. (canceled)

3. (canceled)

4. The mixed binder recited in claim 1, wherein the mixed binder is configured to be used in one or more of the following: a coin cell, a pouch cell, a cylindrical cell, or a prismatic cell with a wound configuration or a stacked configuration.

5. A method, comprising:
applying heat at a first temperature to an electrode, wherein:
the electrode includes a mixed binder which in turn includes a polyacrylic acid (PAA) and a polyimide (PI);
the mixed binder binds a silicon monoxide anode and a current collector in the electrode;
the mixed binder comes into contact with an electrolyte solution in the electrode;
the electrolyte solution includes a lithium-based electrolyte solution and includes one or more of the following: ethylene carbonate (EC), ethyl-methyl carbonates (EMC), dimethyl carbonate (DMC), or lithium hexafluorophosphate (LiPF6);
the mixed binder further includes carboxymethyl cellulose (CMC) and lithium hydroxide; and
the mixed binder includes 10% polyimide and 5% polyacrylic acid by weight and
after applying heat at the first temperature, applying heat at a second temperature to the electrode, wherein the second temperature is hotter than the first temperature; and
calendering the electrode by compressing the electrode to reduce a size of pores in the electrode and increase adhesion between the anode and the current collector.

6. The method recited in claim 5 further comprising: after applying heat at the second temperature, applying heat at a third temperature to the electrode, wherein the third temperature is hotter than the second temperature.

7. (canceled)

8. A computer program product, the computer program product being embodied in a non-transitory computer readable storage medium and comprising computer instructions for:
applying heat at a first temperature to an electrode, wherein:
the electrode includes a mixed binder which in turn includes a polyacrylic acid (PAA) and a polyimide (PI);
the mixed binder binds a silicon monoxide anode and a current collector in the electrode;
the mixed binder comes into contact with an electrolyte solution in the electrode;
the electrolyte solution includes a lithium-based electrolyte solution and includes one or more of the following: ethylene carbonate (EC), ethyl-methyl carbonates (EMC), dimethyl carbonate (DMC), or lithium hexafluorophosphate (LiPF6);
the mixed binder further includes carboxymethyl cellulose (CMC) and lithium hydroxide; and
the mixed binder includes 10% polyimide and 5% polyacrylic acid by weight and
after applying heat at the first temperature, applying heat at a second temperature to the electrode, wherein the second temperature is hotter than the first temperature; and
calendering the electrode by compressing the electrode to reduce a size of pores in the electrode and increase adhesion between the anode and the current collector.

9. The computer program product recited in claim 8 further comprising computer instructions for: after applying heat at the second temperature, applying heat at a third temperature to the electrode, wherein the third temperature is hotter than the second temperature.

10. (canceled)

11. (canceled)

12. (canceled)

13. (canceled)

14. (canceled)

15. (canceled)

16. (canceled)
